(19) United States
(12) Patent Application Publication
(10) Pub. No.: US 2020/0406507 A1
(43) Pub. Date: Dec. 31, 2020

(54) ELECTRIC FIBER ORIENTATION OF FIBER-REINFORCED THERMOPLASTIC

(71) Applicant: DENSO International America, Inc., Southfield, MI (US)

(72) Inventor: Jeffrey GRIGNON, Plymouth, MI (US)

(21) Appl. No.: 16/454,212

(22) Filed: Jun. 27, 2019

(51) Int. Cl. B29C 33/00; B29C 65/36; D01B 9/00

(52) U.S. Cl. CPC B29C 33/0083; B29B 9/10; D01B 9/00; B29C 65/3636

(57) ABSTRACT

A fiber-orientation system for a fiber-reinforced thermoplastic is provided. In various embodiments, the system includes a first tool, and a second tool that, in combination with the first tool, defines a gap therebetween configured to define a flow path for a fiber-reinforced thermoplastic melt during an injection molding. A plurality of electrodes are disposed in the first tool. The electrodes have exposed ends disposed in or along the flow path such that the electrodes are configured to, when energized, orient fibers within the thermoplastic melt. This provides a localized, controllable modification of the orientation of the fibers within the melt.

### TECHNICAL FIELD

The present disclosure relates to a system and tool for orientating fibers within a fiber-reinforced thermoplastic.

### BACKGROUND

Fiber-reinforced thermoplastics offer various desirable qualities, particularly in high-volume, high-performance applications in the automotive industry. Conventional injection-molding equipment can be adapted to produce fiber-reinforced thermoplastics, in which a polymer melt fills a mold, and fibers are dispersed within the melt. The fibers orient themselves depending on the flow characteristics of the melt. Orientation of the fibers within the polymer may ultimately affect the strength, stiffness, flexure, edge hardness, etc. of the final thermoplastic product. Flow-induced effects make it difficult to optimize the fiber orientations and control the mechanical properties of the injection-molded polymer.

### SUMMARY

In one embodiment, a fiber-orientation system for a fiber-reinforced thermoplastic is provided. The system includes a first tool, and a second tool that, in combination with the first tool, defines a gap therebetween configured to define a flow path for a fiber-reinforced thermoplastic melt during an injection molding. A plurality of electrodes are disposed in the first tool. The electrodes have exposed ends disposed in or along the flow path such that the electrodes are configured to, when energized, orient fibers within the thermoplastic melt.

In another embodiment, a fiber-orientation system for a fiber-reinforced thermoplastic is provided. A tool has an interior surface and defining a plurality of pockets, wherein the interior surface at least partially defines a mold for a thermoplastic melt. A plurality of electrodes are disposed in the pockets, wherein the electrodes are configured to energize in a pulsating manner as the thermoplastic melt flows in the mold to change orientation of fibers disposed within the thermoplastic melt.

In yet another embodiment, a method of orientating fibers in a thermoplastic melt is provided. The method includes injecting a fiber-reinforced thermoplastic melt into a mold between a first die and a second die. The method also includes during the injecting, orientating fibers in the thermoplastic melt by energizing electrode shafts disposed within the first die.

### BRIEF DESCRIPTION OF THE DRAWINGS

FIG. 1 illustrates a flow of a polymer melt and an orientation of fibers within the melt, according to prior art applications.

FIG. 2 illustrates a side schematic view of tooling configured for injection molding of fiber-reinforced thermoplastic material, according to one embodiment.

FIG. 3 illustrates a cross-sectional view of a mold having an upper die and a lower die for plastic injection molding tooling equipped with electrodes for aligning fibers in the plastic melt as the melt flows through the mold, according to one embodiment.

FIGS. 4A-4B illustrates a schematic of an effect of active electrodes in aligning the fibers within the melt, according to one embodiment.

FIG. 5 illustrates a flow of a polymer melt and a controlled orientation of fibers within the melt in response to the utilization of the electrodes in the mold, according to one embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Conventional injection-molding equipment can be adapted to produce fiber-reinforced thermoplastics, in which a polymer melt fills a mold, and fibers are dispersed within the melt. The fibers typically orient themselves depending on the flow characteristics of the melt. However, if left to orient themselves based purely on the flow of the melt, the fiber orientation can negatively affect certain characteristics of the final thermoplastic product. For example, an improper or uncontrollable fiber orientation can degrade structural rigidity, stiffness, and other such qualities for the particular application sought.

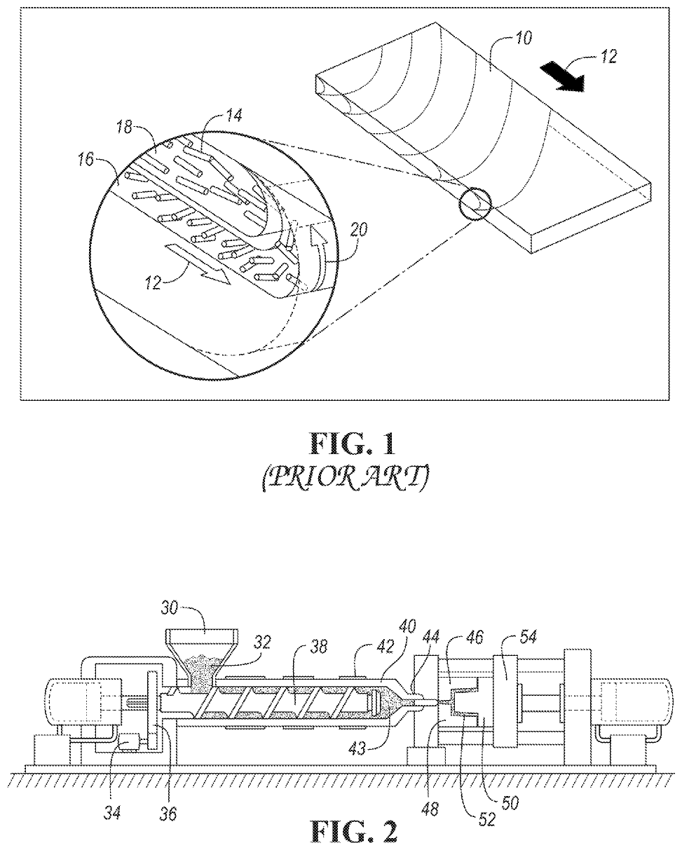

FIG. 1 illustrates an embodiment of such a system. A polymer melt 10 is shown flowing along a flow direction 12. As shown in the enlarged region of FIG. 1, the polymer melt 10 has fibers 14 dispersed therein. As the polymer melt 10 flows in the flow direction 12, the fibers 14 are constantly transferred from a core layer 16 to a boundary layer 18 of the polymer melt 10, as shown by arrow 20. Said another way, as the polymer melt 10 flows, the fibers 14 move along the flow direction 12 and are then redirected along arrow 20 to a boundary layer 18 (e.g., the outer periphery of the melt). This can change the orientation of the fibers 14. For example, as shown in FIG. 1, the fibers in the core layer 16 are orientated with their length generally transverse to the flow direction, while the fibers in the boundary layer 18 are orientated with their length more closely parallel to the flow direction 12.

Previous systems have been implemented in attempts to control the orientation of the fibers in the melt. In one implementation, the entire tool (e.g., lower die and upper die) itself is electrically charged, and the melt is pre-impregnated with fibers (e.g., carbon fibers). Thus, as the carbon fiber flows through the mold, the charge of the upper and lower dies of the mold attempt to control the fiber orientation. However, this can lead to inaccurate control of the fiber orientation, non-localized orientation of the fibers, and requires the use of specific pre-impregnated fibers in the thermoplastic melt.

According to various embodiments disclosed herein, a system and tool for orientating fibers within a fiber-reinforced thermoplastic is provided. In various embodiments, the mold used in the thermoplastic injection process is provided with a plurality of electrodes. The electrodes may be rods, poles, shafts, or the like disposed along the flow path of the thermoplastic melt, and exposed ends of the electrodes may make contact with the melt during the injection process. The electrodes may be configured to pulse at a high voltage and low amperage, with the pulsing reorientating the fibers as the thermoplastic melt travels along the flow direction. The electrodes can be provided in localized areas of the mold, so as to provide reorientation of the fibers at localized regions of the melt during injection.

FIG. 2 illustrates one embodiment of a side schematic view of tooling configured for injection molding of fiber-reinforced thermoplastic material. This is but one embodiment capable of and configured to utilize electrodes in the mold that will be described with reference to FIGS. 2-5. The system of FIG. 2 includes a feed hopper 30 that contains the thermoplastic material 32, which can initially be in a solid state. A motor 34 and associated gears 36 turn a reciprocating screw 38. Turning of the screw 38 moves the thermoplastic material in the barrel 40 along a linear direction of the screw. Meanwhile, a plurality of heaters 42 may be provided to melt the thermoplastic 32 as it travels along the barrel 40. Once melted, thermoplastic melt 43 can be injected via a nozzle 44 into a mold 46. The mold 46 includes a first die 48 and a second die 50, and the thermoplastic melt 43 travels in a gap 52 between the dies 48, 50 to take the shape of the gap between the dies 48, 50. At least one of the dies 48, 50 may also move relative to the other die during operation. For example, the second die 50 may be coupled to a moveable platen 54 that can be moved toward and away from the first die 48 via, e.g., hydraulics. Once cooled, the thermoplastic melt 43 hardens and solidifies, taking the shape of the mold where the thermoplastic has been injected.

The tooling and mold shown in FIG. 2 is but one example of a thermoplastic injection system that can be used with the electrodes explained below. For example, the electrodes explained below can be implemented in the first die 48 and/or the second die 50.

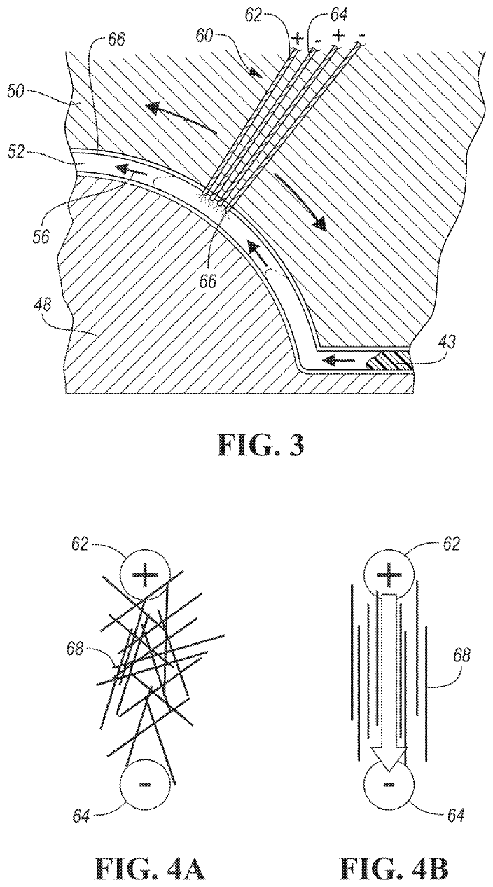

FIG. 3 shows a cross-sectional view of a mold, namely a first die 48 and a second die 50. A gap 52 exists between the dies 48, 50 for the thermoplastic melt 43 to travel into and take the shape of the mold. The thermoplastic melt 43 travels along the direction of the arrows 56. One of the dies 48, 50—in this embodiment, the second die 50—is provided with a plurality of electrodes 60. The electrodes 60 may be embedded, fixed, attached, or otherwise secure to or within the second die 50. The die 50 may include pockets such as embossments or grooves that are sized to receive a respective electrode.

In one embodiment, after a dielectric coating has been applied to interior faces of the die 50, the electrodes 60 can be installed into the die 50. While only four electrodes are shown in FIG. 3, it should be understood that hundreds or thousands of electrodes can be placed along the melt flow path of the mold, depending on the size or shape of the mold. Each electrode 60 can have a mating electrode. In other words, a positive electrode 62 can be disposed adjacent to a corresponding negative electrode 64. In some embodiments, each electrode 60 has multiple mating electrodes, with positive or negative mates depending on the flow direction. In some embodiments, the positive electrode can be on a first die, and the negative electrode can be on a second die, or vice versa.

The electrodes 60 can be connected to an external circuit controller (not shown), wherein the circuit supplies a controlled high voltage, low amperage current that discharges between the tips or ends of the electrodes, creating polar fields around the plastic melt. In one embodiment, the “high voltage” supplied is 10,000 volts, or higher. In one embodiment, the “low amperage” supplied is in the range of 1-10 milliamps, and can be negligible and generally zero.

Each electrode 60 has a tip 66 exposed within the gap 52. Each tip 66 may directly contact the thermoplastic melt 43 as the thermoplastic melt 43 flows in the mold. The tips 66 may extend into the gap 52 from the die 50. In another embodiment, the end of each tip 66 is coplanar and in-line with the interior surface 67 of the die 50 so as to not impart a bumped shape onto the thermoplastic during cooling of the thermoplastic melt 43. A thin layer of material (e.g., metal, glass, etc.) may be placed over the electrode tips 66.

In operation, as the thermoplastic melt 43 travels along the direction of arrow 56 into the mold, the circuit can supply a controlled high voltage, low amperage current to the electrodes 60 that discharges between the tips 66 of the electrodes. This creates polar fields around the thermoplastic melt 43. As the electrodes 60 are energized, the electrodes 60 may be located and configured such that the current does not pass directly through the thermoplastic melt 43, but rather creates an electric field with polarity that can affect all fibers within range of the electric field and “snap” the fibers into a desired orientation. A theoretical center-to-center line of mating electrodes can dictate the final fiber centerline orientation of all localized fiber.

FIGS. 4A-4B illustrates a schematic of an effect of active electrodes in aligning the fibers within the melt. FIG. 4A shows a positive electrode 62 and a negative (or grounded) electrode 64. The electrodes 62, 64 are not energized such that no current is supplied to the electrodes 62, 64, and no polar field is created around the thermoplastic melt. Thus, fibers 68 of the thermoplastic melt are not commonly oriented. There can be a disarray or non-uniformity amongst the fibers 68.

Once energized with a high voltage, low amperage current, the electrodes 62, 64 create a polarity that affects the fibers 68 by snapping them into a uniform alignment. This is shown in FIG. 4B. The fibers 68 can be aligned such that their length is aligned parallel with the flow direction. The fibers can also be controlled to be aligned in other directions, such as perpendicular or angled relative to the flow direction, depending on the desired characteristics.

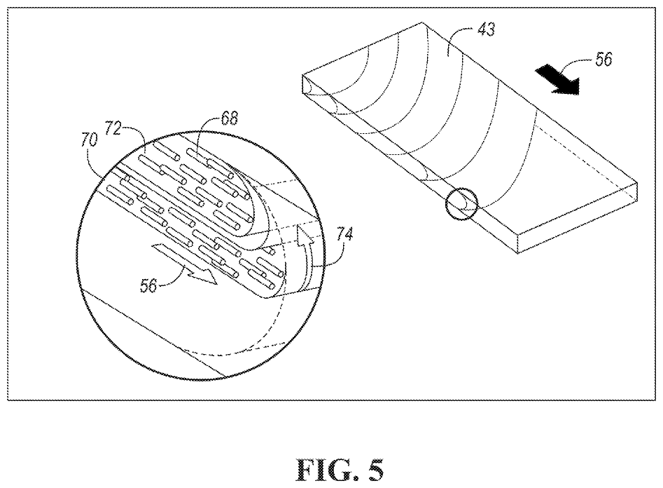

FIG. 5 illustrates the results and impact of utilizing the electrodes 60 on the thermoplastic melt during the injection process. Unlike the properties of the melt in FIG. 1, in which the fibers in the core layer are orientated opposite or different than the fibers in the boundary layer, in FIG. 5 the electrodes 60 create a melt with all fibers in the core layer and the boundary layer located in a uniform direction. For example, the thermoplastic melt 43 is shown flowing along a flow direction 56. As shown in the enlarged region of FIG. 5, as the polymer melt 43 flows in the flow direction 56, the fibers 68 are constantly transferred from a core layer 70 to a boundary layer 72 of the thermoplastic melt 43, as shown by arrow 74. Said another way, as the thermoplastic melt 43 flows, the fibers 68 move along the flow direction 56 and are then redirected along arrow 74 to the boundary layer 72. This might normally change the orientation of the fibers 68. But, the energization of the electrodes reorients the fibers 68 such that the fibers 68 maintain their orientation even after transitioning into the boundary layer 72. Thus, all fibers 68 throughout the thermoplastic melt 43 can maintain a uniform orientation and direction.

A controller (not shown) having a processor for controlling the energization of the electrodes may be provided. The controller can be any suitable controller for monitoring and/or controlling the power supply to the electrodes, including modifying the voltage and amperage in the current, reducing the power supply in response to the heat of the melt increasing beyond a threshold, etc. In this disclosure, the terms “controller” and “system” may include processor hardware (shared, dedicated, or group) that executes code and memory hardware (shared, dedicated, or group) that stores code executed by the processor hardware. The code is configured to provide the features of the controller and systems described herein. In one example, the controller may include a processor, memory, and non-volatile storage. The processor may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory. The memory may include a single memory device or a plurality of memory devices including, but not limited to, random access memory (“RAM”), volatile memory, non-volatile memory, static random-access memory (“SRAM”), dynamic random-access memory (“DRAM”), flash memory, cache memory, or any other device capable of storing information. The non-volatile storage may include one or more persistent data storage devices such as a hard drive, optical drive, tape drive, non-volatile solid-state device, or any other device capable of persistently storing information. The processor may be configured to read into memory and execute computer-executable instructions embodying one or more software programs residing in the non-volatile storage. Programs residing in the non-volatile storage may include or be part of an operating system or an application, and may be compiled or interpreted from computer programs created using a variety of programming languages and/or technologies, including, without limitation, and either alone or in combination, Java, C, C++, C#, Objective C, Fortran, Pascal, Java Script, Python, Perl, and PLSQL. The computer-executable instructions of the programs may be configured, upon execution by the processor, to cause the controller to supply an electric current (via a power source) to the electrodes, and control the timing and duration of the electric current.

The controller can be utilized such that some electrodes can be supplied with a lower voltage than other electrodes. Alternatively or additionally, the voltage supplied to the electrodes can vary over time throughout the injection process. For example, the controller can be programmed to cause a first voltage to be sent to the electrodes during an initial portion of the injection process, and a second voltage to be sent to the electrodes during a subsequent or final portion of the injection process. Alternatively or additionally, the system can be configured such that a first group of electrodes are energized during a first phase of the injection process, and then a second group of electrodes are energized during a second phase of the injection process. This can enable sequential or stepped fiber alignment or orientation in the melt. In other words, this can allow a group of fibers in one area of the melt to be aligned or orientated, followed sequentially by another group of fibers in another area of the melt to be aligned or orientated. This can also allow the fibers to be non-uniform or not oriented before the injection process and during initial phases of the injection process, and then during the flow of the melt, the fibers can be oriented via the electrodes.

The power supply to the electrodes via the controller can also be configured to be supplied in a pulsed or strobed manner. Pulsing of the electric current, as opposed to a constant supply of current, can reduce the risk of burning the thermoplastic melt. If high voltage (e.g., over 10,000V) is constantly supplied to the electrodes for orientating the fibers, the melt may be prone to overheating and/or burning, which can significantly impact the structural characteristics of the resulting thermoplastic. The pulsing supply of voltage to the electrodes can reduce this potential by providing momentary times of a lack of supply of energy, allowing the melt to recover from the heating at the interface of the electrodes.

The incorporation of electrodes into one or more of the dies of the injection system allows localized and complete control over the orientation of the melt, and therefore the resulting plastic part. The control of the power supply to the electrodes can allow the same part to be engineered with completely different physical characteristics (e.g., profile stiffness, snap-feature flexure, edge hardness, etc.) by modifying the power supply to the electrodes. Moreover, the electric thermoplastic fiber orientation of this disclosure allows physical characteristics of individual features to be engineered to a much higher degree, such as thickness efficiency, fillet spring rate, profile stiffness, snap-feature flexure, edge hardness, and other characteristics. Physical characteristics across a single part could, by design, vary significantly, and even feature-to-feature variance can be provided. For example, fibers could be oriented in a certain manner at one portion of the part, and in another manner at a different portion of the part.

In one embodiment, the resulting part can have fibers that are snapped or orientated in a single direction all throughout the part, instead of fibers that change with the melt flow direction and/or the shape of the mold. This is not possible by conventional methods of fiber orientation.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

1. A fiber-orientation system for a fiber-reinforced thermoplastic, the fiber-orientation system comprising:
a first tool;
a second tool that, in combination with the first tool, defines a gap therebetween configured to define a flow path for a fiber-reinforced thermoplastic melt during an injection molding; and
a plurality of electrodes disposed in the first tool, wherein each electrode has a corresponding mating electrode within the plurality of electrodes in the first tool along a same side of the flow path, wherein the electrodes have exposed ends disposed in or along the flow path such that the electrodes are configured to, when energized, orient fibers within the thermoplastic melt.

2. The fiber-orientation system of claim 1, wherein the electrodes are supplied with a voltage of 10,000 volts or greater.

3. The fiber-orientation system of claim 1, wherein the electrodes are supplied with an amperage of 10 milliamps or less.

4. The fiber-orientation system of claim 1, wherein the plurality of electrodes includes a positive electrode and a negative or grounded electrode, and energizing of the electrodes creates a polar field around the thermoplastic melt.

5. The fiber-orientation system of claim 4, wherein a center-to-center line between the positive electrode and the negative or grounded electrode corresponds to a centerline orientation of effected fibers in the polar field.

6. The fiber-orientation system of claim 1, wherein the electrodes are configured to energize in a pulsed manner.

7. The fiber-orientation system of claim 1, wherein the electrodes are configured to energize in a sequential manner in which a first group of the electrodes energize and subsequently a second group of electrodes energize.

8. The fiber-orientation system of claim 1, wherein the first tool includes a plurality of pockets and the electrodes are disposed in the pockets.

9. A fiber-orientation system for a fiber-reinforced thermoplastic, the fiber-orientation system comprising:
a tool having an interior surface and defining a plurality of pockets, wherein the interior surface at least partially defines a mold for a thermoplastic melt; and
a plurality of electrodes disposed in the pockets; and
a controller programmed to energize the electrodes in a pulsating manner as the thermoplastic melt flows in the mold to change orientation of fibers disposed within the thermoplastic melt.

10. The fiber-orientation system of claim 9, wherein each electrode includes a tip that is exposed to the thermoplastic melt as the thermoplastic melt flows in the mold.

11. The fiber-orientation system of claim 10, wherein the tips of the electrode are coplanar with the interior surface.

12. The fiber-orientation system of claim 9, further comprising a second tool that, in combination with the tool, defines a gap therebetween configured to define the mold.

13. The fiber-orientation system of claim 12, wherein each electrode includes a tip that is exposed in or adjacent to the gap.

14. The fiber-orientation system of claim 9, wherein the electrodes are supplied with a pulsating voltage of 10,000 volts or greater.

15. The fiber-orientation system of claim 9, wherein the electrodes are supplied with a pulsating amperage of 10 milliamps or less.

16. The fiber-orientation system of claim 9, wherein the plurality of electrodes includes a positive electrode and a negative or grounded electrode, and energizing of the electrodes creates a pulsating polar field around the thermoplastic melt.

17. A method of orientating fibers in a thermoplastic melt, the method comprising:
injecting a fiber-reinforced thermoplastic melt into a mold between a first die and a second die; and
during the injecting, orientating fibers in the thermoplastic melt by energizing electrode shafts disposed within the first die.

18. The method of claim 17, wherein the energizing includes supplying an electric current of at least 10,000 volts and less than 10 milliamps to the electrode shafts.

19. The method of claim 18, wherein the supplying of the electric current is a pulsed supply.

20. The method of claim 17, wherein the energizing includes a sequential energizing of a first group of the electrode shafts and then a second group of the electrode shafts.
